(19) United States
(12) Patent Application Publication
(10) Pub. No.: US 2002/0162940 A1
(43) Pub. Date: Nov. 7, 2002

(54) System for regulating mold temperature

(75) Inventors: Viktor Frul, Nashua, NH (US); Steven K. Ettelson, Hollis, NH (US)

Correspondence Address: Hayes, Soloway, Hennessey,, Grossman & Hage, PC, 175 Canal Street, Manchester, NH, 03101, US

(73) Assignee: Brookfield Innovations Inc.

(21) Appl. No.: 09/846,624

(22) Filed: May 1, 2001

(51) Int. Cl. B29C 45/37; B22D 27/02; B29B 7/00

(52) U.S. Cl. 249/79; 425/552

(57) ABSTRACT

A thermally regulated injection mold in which the tooling layer is a relatively thin layer supported by a rib structure disposed on the rear surface. The temperature of the mold is controlled by impinging the rear surface of the tooling layer with a heated fluid medium or a fluid cooling medium.

### FIELD OF INVENTION

The present invention relates to a method and apparatus for heating and cooling injection molds for the production of plastic articles.

### BACKGROUND

In order to achieve a high level of economic efficiency in the production of injection molded plastic articles, it is necessary to minimize the cycle time of production. The injection molding cycle comprises 5 basic steps: closing the mold, injecting the molten plastic, packing the mold, cooling the plastic article, and ejecting the plastic article. In specialized circumstances it is also advantageous the heat the mold prior to injecting the molten plastic, but subsequent to the ejection of the previous part. Of these steps the heating and cooling of the mold are by far the most time consuming. Rapid heating and cooling of injection molds is inhibited by the fact that, because of the large amount of stress placed on the mold resulting from the required clamping forces and injection pressures, injection molds are typically large steel monoliths. This large thermal mass requires a great deal of energy to heat, and conversely a large amount of heat must be removed to cool the mold, therein requiring a substantial amount of time to carry out either operation.

Various attempt at reducing the cooling and/or heating times of molding apparatus can be found in the relevant art. U.S. Pat. No. 5,824,237 discloses a mold system having an insert, forming the tooling surface, made from a material with a higher thermal diffusivity than that of the rest of the mold. The insert further contains a cooling means. this provides a mold system in which the insert can be cooled more quickly than could a steel mold. The higher thermal diffusivity of the tooling surface allows the surface to be heated and cooled relatively independently of the remainder of the mold.

Rapid heating of molds for plastic articles is disclosed in U.S. Pat. No. 5,569,474. The disclosed method is the application of a thin film electric resistor to the tooling surface of a mold cavity and/or core. Upon application of electrical potential to the thin film resistor, the thin film increases in temperature, therein providing an elevated temperature to the tooling surface without necessitating heating the entire mold.

Another apparatus and method for controlling the temperature of an injection mold is disclosed in U.S. Pat. No. 5,855,933, in which the cooling channels are located very close to the tooling surface of the mold, and the cooling channel path conforms to, or is optimized to, the geometry of the core and cavity respectively. The channels are formed in the mold by cutting each of the mold portions along planes corresponding to the desired path of the cooling channels. The channels are cut into the mold sections, and then the mold sections are brazed back together to reform the original mold portions.

In the process of slush molding, or plastisol casting, the use of forced air directed across the back of a mold for heating and cooling of the mold is known. The use of forced convection temperature control for slush molding is disclosed in such patents as U.S. Pat. No. 5,221,539 (Pallerberg et al.) Jun. 22, 1993; 5,445,510 (Jackson, Jr.) Aug. 29, 1995; 4,623,503 (Anestis et al.) Nov. 18, 1986; and 4,621,995 (Wersosky) Nov. 11, 1986.

From the above, the use of forced convection temperature control has been fairly well-established in the field of slush molding. this process obviates the need for large ovens and/or conductive heaters. Forced convection temperature control also allows better control over the thickness of slush molded plastic articles. It is possible with this technique to either balance or profile the temperature within a mold.

However, the effectiveness of forced convection temperature control of a mold depends, in part, on the thickness of the tool shell. If the mold is too thick the response time to a temperature control input decreases greatly, resulting from the increase in thermal mass in which the temperature change must be effected and the increase in distance across which the temperature change must be effected. The necessity of minimizing the tool thickness result in mold of relatively small structural integrity. This is not a problem for slush molding, an inherently very low mold-stress process, however, this limitation greatly restricts the application of this principle to other plastics molding processes, many of which require a mold possessing exceptionally high strength.

### SUMMARY OF THE INVENTION

A method of thermally regulating an injection mold for forming plastic articles comprising the steps of impinging the rear surface of the mold cavity with a fluid heating medium to heat the mold, and impinging the rear of the mold cavity with a fluid cooling medium to cool the mold. Preferably both the fluid heating medium and the fluid cooling medium comprise a liquid or a gas. More preferably the fluid heating medium comprises air, and the fluid cooling medium comprises water or an air/water mixture.

The present invention is further directed at an injection mold capable of being thermally regulated by impingement with a heated fluid medium and a cooled fluid medium. The mold of the present invention comprises a cavity defined by a relatively thin tool surface that is of uniform thickness, a support structure behind the tool surface, and at least one heating and/or cooling impingement nozzle.

The present invention is also directed at a method of making molds capable of being thermally regulated by impingement. The method of production preferably comprising: the design of the mold and mold components using conventional CAD software, using the designs to produce models by means of rapid prototyping tools, and using the models for investment casting and forming electroplate shells.

### BRIEF DESCRIPTION OF THE DRAWINGS

FIG. 1 is a sectioned view of the cavity insert.

FIG. 2 illustrates the elements of the present invention separated into discrete components.

FIG. 3 is an isometric view of the heating system, including the manifold and nozzles.

FIG. 4 illustrates the bottom plate of the mold insert with the cooling nozzles attached, shown in an isometric view.

FIG. 5 illustrates is a front angle exploded view of the mold insert.

FIG. 6 is a sectioned view of the core insert.

FIG. 7 graphically illustrates the coordination of an injection molding cycle with the heating and cooling of a mold.

FIG. 8 is an illustration, in block diagram, of the method of design and fabrication of the mold of the present invention.

FIG. 9 illustrates and exemplary article molded using a mold system consistent with the present invention.

FIG. 10 illustrates a core insert, containing an impingement cooling system, in two sectioned views.

FIG. 11 is a representational view of a vertical tube with cooling nozzles attached.

FIG. 12 illustrates a cavity insert and impingement cooling system in exploded view.

FIG. 13 is another exploded view of a cavity insert and impingement cooling system.

### DETAILED DESCRIPTION OF THE PREFERRED EMBODIMENTS

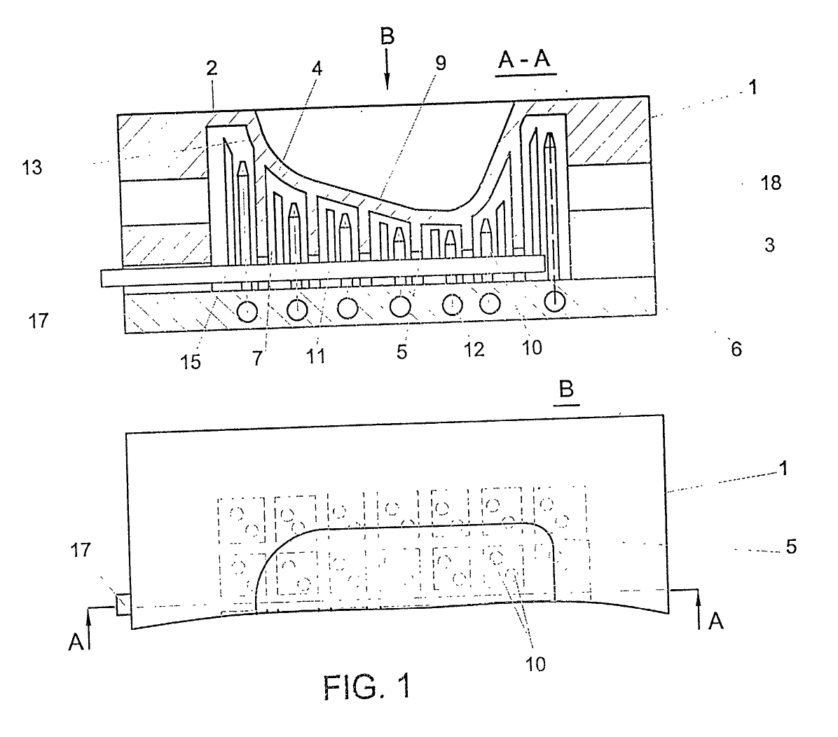

With reference to FIG. 1, the apparatus of the present invention comprises a mold insert, shown generally at 1. Mold insert 1 comprises a support frame 3 with a mold cavity 2 disposed centrally within. Support frame 3 is of sufficient size and structural integrity to withstand mold clamping pressure and prohibit deformation or destruction of mold cavity 2 under clamping pressure. Mold cavity 2 comprises an active layer 4, and a support structure 5 disposed beneath active layer 4. A heating system 11, and a cooling system 12 are disposed within support structure 5, wherein cooling system 12 is further connected to support plate 6, attached to the bottom surface of support frame 3.

Active layer 4 is of a uniform thickness of between about 3-15 mm, preferably about 6 mm, and comprises an outer working surface 9 which defines the shape of the plastic article to be formed, and an inner heat-exchange surface 13. The relatively small thickness of active layer 4 allows for rapid heat transfer across its thickness, and therefore requiring a relatively small amount of energy applied to heat-exchange surface 13 to effect a temperature change at working surface 9. Additionally the uniform thickness of active layer 4 provides uniform heat transfer about the entire cavity. Projecting from heat-exchange surface 13, and integral with active layer 4, is support structure 5. Support structure 5 comprises a plurality of orthogonal ribs 8 which provide sufficient structural integrity to active layer 4 to resist the hydrostatic force of injection and packing of molten plastic.

The orthogonal arrangement of ribs 8 produce a plurality of cells 7 which are in communication with one another by way of openings 24 in ribs 8. In the preferred embodiment of the present invention, each of the ribs 8 has a thickness of 4 mm, and the ribs 8 are spaced 24 mm on center, therein providing cells 7 measuring 20 mm by 20 mm. Discharge passage 18 is provided through support frame 3 so as to provide communication between the exterior of mold insert 1 and cells 7. The mold insert 1 further contains bottom plate 6, which serves to seal cells 7, and further provide support for heating system 11 and cooling system 12.

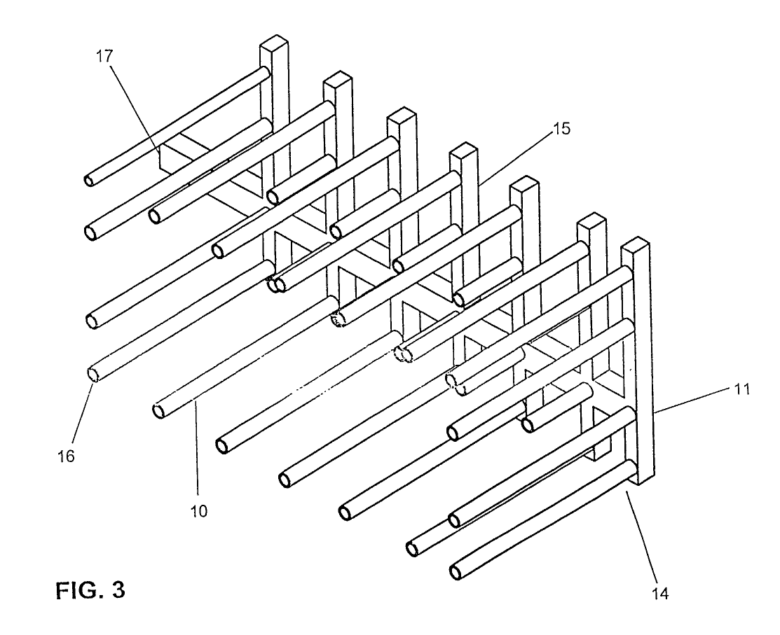

Heating system 11 provides for the heating of active layer 4 by impingement of active layer 4 with heated fluid medium, preferably heated gaseous medium, and more preferably heated air. As illustrated in FIG. 3, heating system 11 comprises a manifold, 14 generally, and nozzles 10. The manifold 14 is fed with heated air through inlet 17. The heated air is distributed to nozzles 10 by way of distribution tubes 15. The nozzles 10 are of determined height such that the distance between each nozzle tip 16 and heat-exchange surface 13 is uniform. The height of each of the nozzles 10 will vary with the profile of the active layer 4, which is in turn determined by the profile of the desired end plastic article. The number and arrangement of nozzles 10 are such that each cell 7, of support structure 5, is provided with one nozzle 10.

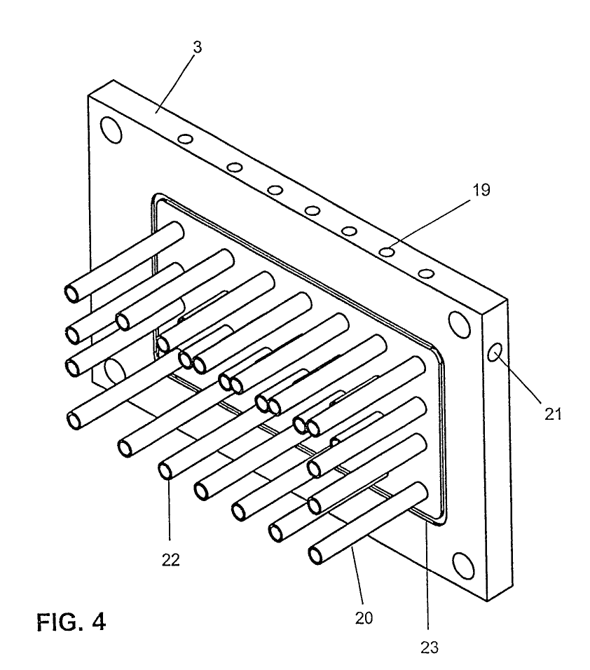

The cooling system 12 provides cooling of active layer 4 by impingement of active layer 4 with a fluid cooling medium, preferably a liquid cooling medium, and more preferably water or brine. Alternately, cooling may be provided by impingement of active layer 4 with a fluid cooling medium comprising an air/water mixture, such as an air/water mist. Cooling system 12, illustrated in FIG. 4, comprises bottom plate 6 and nozzles 20 extending therefrom. Bottom plate 6 contains at least one inlet 19 in communication with nozzles 20, therein allowing flow of cooling medium from inlet 19 through nozzles 20. As with the heating nozzles 10, the cooling nozzles are of appropriate number and placement to provide one nozzle 20 to each cell 7 of support structure 5. Also, as with heating system 11, nozzles 20 or of determined height to provide a uniform distance between nozzle tip 22 and heat-exchange surface 13.

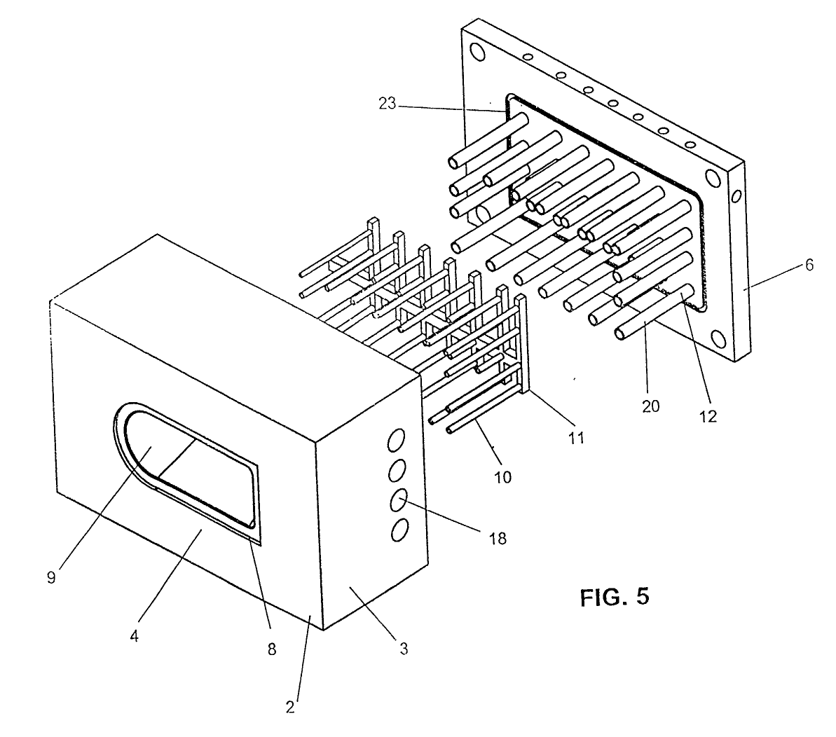

FIG. 5 is an exploded view of the mold insert 1 illustrating the orientation and placement of heating system 11 and cooling system 12.

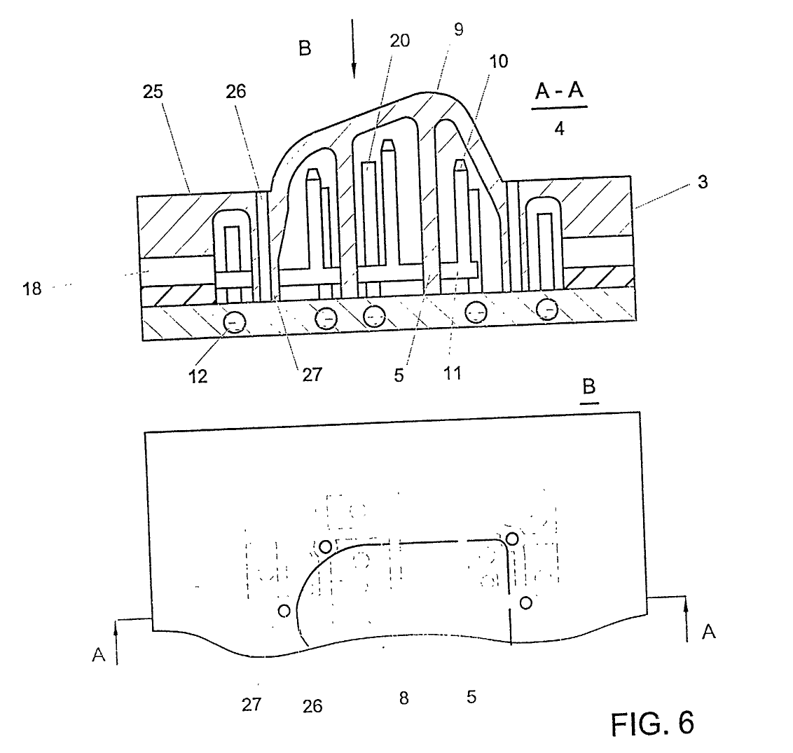

The corresponding core portion of the mold is illustrated at FIG. 6. The layout and construction of core insert 25 is based on the same principle as the layout and construction of the cavity insert 2. The principle difference between core insert 25 and cavity insert 2 is the necessity of an ejection system in core insert 25. An ejection system is provided for by the incorporation of regions of localized thickening 27 in ribs 8 along the path of the ejector pins. The ejector pin holes 26 are drilled through the areas of localized thickening 27 of ribs 8. The ejector pin holes 26 are sealed at the interface of the bottom plate 6 to prohibit the movement of heat-exchange media to the ejector pin holes.

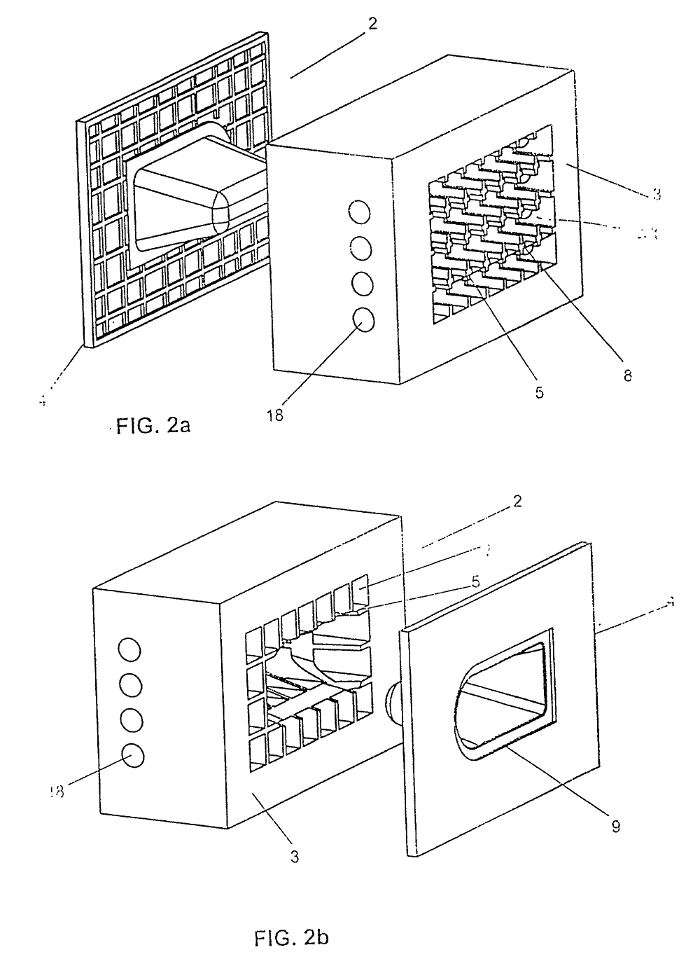

While the preferred embodiment of the present invention has been described as containing the support frame 3, active layer 4, and support structure 5 as a single unitary construction, it is not required that the mold insert be constructed as such. The present invention may also be designed and constructed wherein the support frame 3, the active layer 4, and the support structure 5 are all discrete components, as illustrated in FIG. 2. A greater degree of freedom can be achieved by separating the elements into discrete components. The separation of components may be taken to any desired level. For example, the support frame 3 may be eliminated by providing a suitably dimensioned pocket in the mold base, as is known in the art for use with mold inserts. The active layer 4 and support structure 5 would be placed in the pocket in the mold base in the same manner as a conventional mold insert. The heating system 11 and cooling system 12 would then be positioned within the support structure 5 from the rear and further supported and plumbed with a backing support plate. It is also possible to further separate active layer 4 and support structure 5 into two discrete elements, whereby support structure 5 would be a free standing element within a pocket in a mold and active layer 4 would be positioned within the support structure 5 and peripherally engaged by the mold plate.

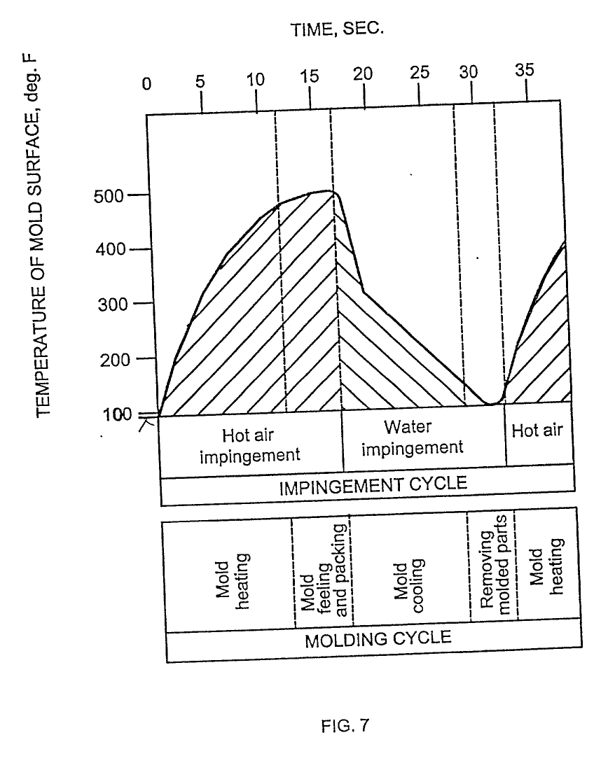

In operation, the mold insert is thermally regulated by impingement of the heat-exchange surface with a heated fluid medium, preferably hot air, or a cold fluid heat transfer medium, preferable water or brine solution. FIG. 7 graphically illustrates the coordination between the stages of an injection molding cycle and the application of heating and cooling. The temperature of the mold is preferably controlled such that the mold surface is at the highest temperature during the injection/pack phase, and at the lowest temperature during the cooling/ejection phases. The coordination of the heating and cooling of the mold and the stages of the injection molding cycle may be controlled in a variety of fashions, i.e. timed or tied to a parameter of the injection molding process.

During mold heating/filling/packing the mold is preferably heated by means of the hot gaseous medium. Mold heating is accomplished by forcing air through an external heater, such as a duct heater, where the air is super heated. From the heater the air is ducted to the heating system inlet 17. The hot air is communicated from inlet 17 through heating system manifold 14 and out nozzles 10. After exiting nozzles 10 the hot air impinges heat-exchange surface 13, therein causing heating of active layer 4. After impinging heat-exchange surface 13 the hot air is forced from the mold through discharge passage 18 by continuing stream of hot air entering the mold through nozzles 10. Because the heat transfer medium must be able to exit the mold, it is necessary that openings 24 in ribs 8 are sufficiently large so as to provide a minimum restriction to the passage of the air from the individual cells 7 to the discharge passage 18. As the air exits the mold, it is preferably recaptured and ducted back to the external heater. By recapturing the vented hot air the system can be made more efficient as the air returning to the heater will have retained some of its heat, and therefore require less energy to bring it up to the desired temperature.

Once the packing stage of the injection molding cycle is complete, the injection molded part must be cooled to a temperature sufficiently low that the part will not deform on ejection. Preferably, the cooling of the mold is accomplished by pumping a liquid cooling medium into the mold via inlet(s) 19 and through nozzles 20. The liquid cooling medium is sprayed out of nozzles 20 and impinges heat-exchange surface 13, and therein rapidly removing heat from active layer 4. The liquid cooling medium, subsequent to impinging heat-exchange surface 13, drains from the mold through discharge passage 18, by way of openings 24. It is preferable that the liquid cooling medium is collected and re-circulated as it leaves the mold, however it is also possible to simply discharge the liquid cooling medium as waste. To further improve the efficiency of the cooling cycle, the liquid cooling medium may be pre-cooled prior to entering the mold, as through the use of a chiller.

In this manner it is possible to very effectively, and very rapidly, effect thermal regulation of a mold. The heating and cooling media are applied directly to the thin wall cavity, active layer 4, and can therefore regulate the effective temperature of the cavity without having to heat and cool the entire mold. Not only does the present invention allow for efficient production of injection molded parts, but, because the mold can be effectively heated to a temperature near that of the melting temperature of the plastic resin, fine detail and thin walled sections can be filled without problems of freeze off.

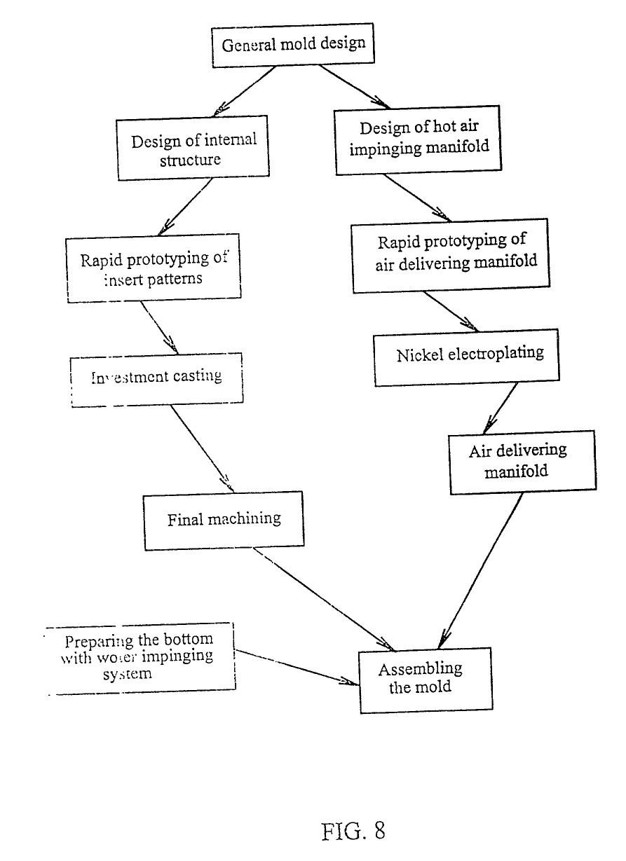

The present invention also provides a method of producing molds thermally regulated by impingement. FIG. 8 is a flow diagram of the general process for producing molds of the present invention. The molds, including the support structure, the heating system, and the cooling system, are designed in a conventional manner using various available CAD packages. The CAD designs are used to prepare sacrificial models, for example through the use of stereolithography or wax thermal jet printing.

The mold insert, comprising support frame 3, active layer 4, and support structure 5 may all be manufactured by conventional techniques known in the art, for example investment casting, etc.

The heating system 11 is formed by electroplating the model of the heating system, comprising the heating nozzles 20 and manifold 14 as a single unit. After the model has been electroplated with an appropriate material, as nickel, to the desired thickness, preferably between 0.4-0.7 mm, the model is burned out leaving a hollow nickel structure.

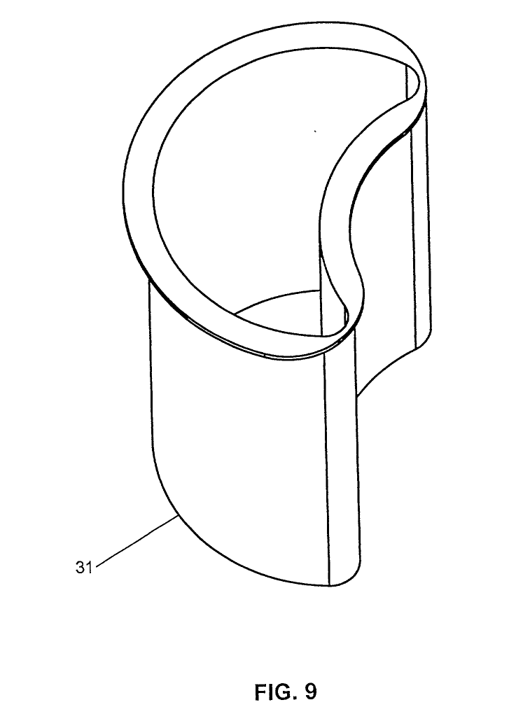

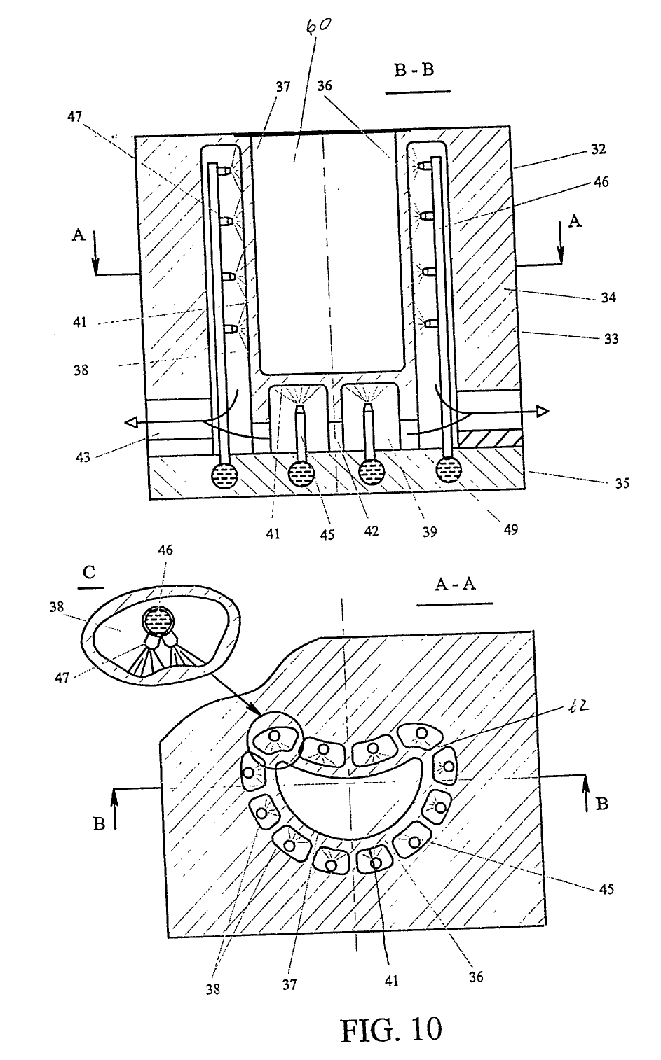

An alternate embodiment of the present invention is illustrated at FIG. 9-FIG. 13. This embodiment of the present invention provides rapid and uniform heat removal from the molding surface by means of impingement with a fluid cooling medium. Impingement cooling is especially useful in the production of plastic articles having a deep cavity, such as that illustrated at 31 in FIG. 9. The mold of this embodiment, illustrated in FIG. 10 A-A and FIG. 10 B-B, comprises an insert 33 having a bottom plate 35 attached thereto. The insert 33 further comprises a cavity 60 defined by active layer 36 of uniform thickness, preferably about 7 mm. Active layer 36 has a working surface 37, which defines the dimensions and geometry of part 31, and a heat-exchange surface 41. The structural integrity required to withstand the hydrostatic injection forces is provided by support structure 40, formed by partition ribs 62. Partition ribs 62 in turn form compartments 38 and 39, displaced around the perimeter of active layer 36, and beneath active layer 36, respectively. Compartments 38 and 39 are connected by openings 42 in partitions ribs 62, and further to the exterior of insert 33 by way of discharge openings 43.

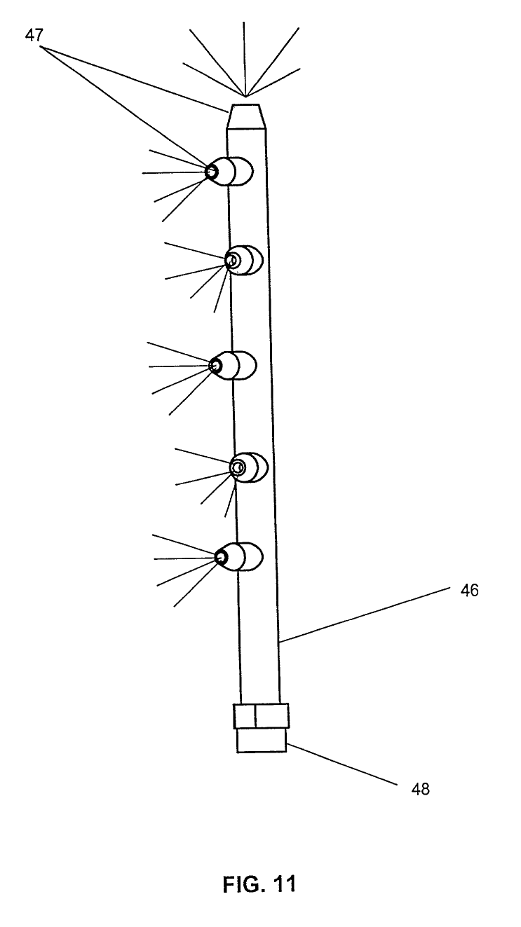

The impingement cooling system 45 preferably comprises vertical tubes 46 having spray nozzles 47 attached thereto. FIG. 11 illustrates the structure of tube 46 and spray nozzles 47 thereon. Each compartment 38 and 39 is provided with a vertical tube 46. The number and placement of nozzles 47 on tube 46 are determined based on the geometry of the individual compartments 38 and 39, the geometry of heat-exchange surface 41, and the cooling requirements of the molding process. Vertical tubes 46 are provided with a threaded end for connection to feed channels 49 disposed within bottom plate 35. Feed channels 49 supply vertical tubes 46 with high pressure water from an external source.

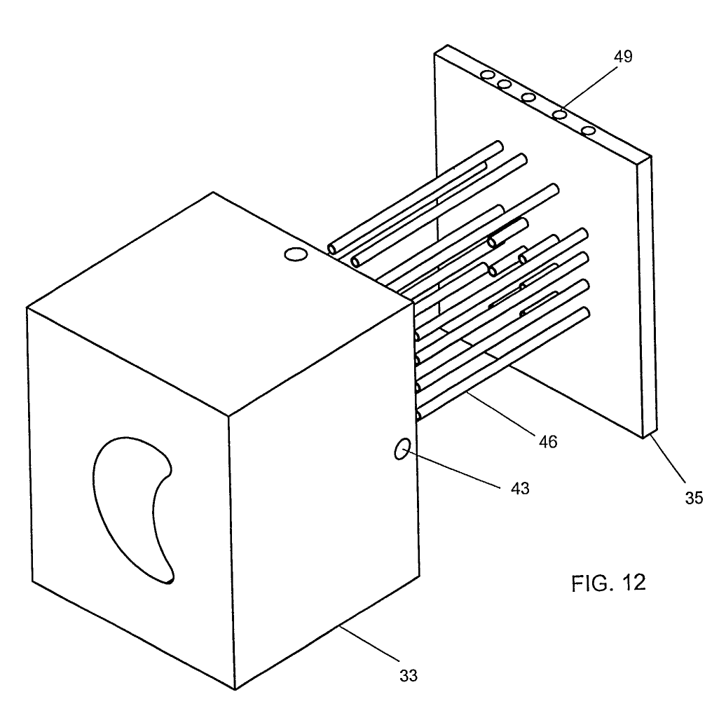

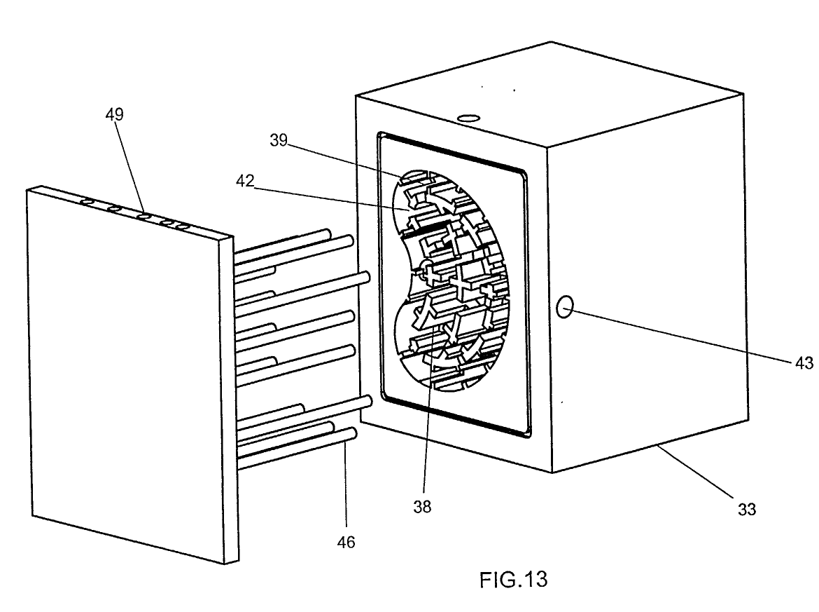

FIG. 12 and FIG. 13 are exploded diagrams of insert 33 and bottom plate 35 with vertical tubes 46 attached thereto. As can be seen in FIG. 13, the location and height of vertical tubes 46 coincides with the location and depth of compartments 38 and 39. Further, as seen in FIG. 12, the location and number of feed channels 49 is dictated by the location of vertical tubes 46. Not shown, when assembled the bottom plate 35 is sealed to insert 33, as by a gasket or other appropriate means, to prevent leakage.

The design and construction of a corresponding core insert (not shown) differs in the necessary incorporation of ejection means. The ejection means typically comprises ejector pins situated in holes drilled through partition ribs and the bottom plate, wherein the pins are present in whatever number and location is required to remove the part from the core section. It is preferred that the ejector holes are sealed at the interface of the partition ribs and the bottom plate to eliminate leakage of cooling medium into the mold cavity.

During operation of the injection mold, a fluid cooling medium, such as high pressure water or air/water mist, preferably from a re-circulating chilled water system, is supplied to the feed channels in the bottom plate, and from there to the vertical tubes and the nozzles. The high pressure water is sprayed on the heat-exchange surface, thereby effecting a very efficient high rate of cooling. The discharge openings in the insert allow the water to continuously drain from the mold. In this way the compartments are always substantially empty of water, and therefore the impingement action of the nozzles is always present. Efficient cooling of the mold comes not only from the impingement action, but also from the uniform, and relatively small, thickness of the active layer. The uniform thickness of the active layer, as well as the uniform distribution of impingement nozzles, ensures uniform cooling. The cooling operation is made even more efficient in that heat transfer only has to be effected through a relatively small amount of mater, as compared with having to control the temperature of a large steel monolith.

The cooling process can be made more efficient by coordinating the spray of the nozzles with the cooling cycle. That is, the flow of water to the nozzles can be made intermittent, wherein the impingement action is only present during the cooling phases of the injection molding cycle. This coordinated cooling action can be accomplished through the use of valves, at the water source or in the mold itself, and an appropriate controller, as by computer control or by linking the valving to a process parameter such as the screw position. This intermittent cooling action may be especially useful in preventing freeze-off when molding thin walled articles.

What is claimed is:

1. A thermally regulated mold for forming plastic articles comprising:
an active layer having a first side and second side;
a support structure comprising a plurality of ribs disposed on the second side of said active layer;
a temperature regulating system comprising at least one nozzle for supplying a fluid heat transfer medium, said nozzle positioned beneath the second side of said active layer, wherein said nozzle is disposed between said ribs.

2. The mold of claim 1 wherein said fluid heat transfer medium is heated.

3. The mold of claim 1 wherein said fluid heat transfer medium is cooled.

4. The mold of claim 2 wherein said fluid heat transfer medium is air.

5. The mold of claim 3 wherein said fluid heat transfer medium is water.

6. The mold of claim 3 wherein said fluid heat transfer medium is an air/water mixture.

7. The mold of claim 1 wherein said support structure is integral with said active layer.

8. The mold of claim 1 wherein said at least one nozzle of said temperature regulating system extends from a manifold.

9. The mold of claim 1 wherein said at least one nozzle of said temperature regulating system extends from a support plate positioned beneath said support structure, said support plate containing at least one internal channel in fluid connection with said nozzle of said temperature regulating system.

10. A method of thermally regulating a mold having a front surface and back surface and a plurality of nozzles disposed behind said back surface, the method comprising:
heating said mold by impinging said back surface of said mold with a first fluid heat-transfer medium at a first temperature, wherein said first fluid heat transfer medium is dispensed from at least one of said nozzles;
cooling said mold by impinging said back surface of said mold with a second fluid heat-transfer medium at a second temperature, wherein said second temperature is less than said first temperature, and said second fluid heat-transfer medium is dispensed from at least one of said nozzles.

11. The method of claim 10, wherein said first fluid heat transfer medium is a gaseous medium.

12. The method of claim 11, wherein said gaseous medium is air.

13. The method of claim 10, wherein said second fluid heat transfer medium is a liquid.

14. The method of claim 13, wherein said liquid medium is water.

15. The method of claim 10, wherein said second fluid heat transfer medium is an air/water mixture.

16. The method of claim 10 further comprising the step of recapturing and recycling said first fluid heat-transfer medium.

17. The method of claim 10 further comprising the step of recapturing and recycling said second heat-transfer medium.

18. The method of claim 10, wherein said impingement with said first and said second fluid heat-transfer media are coordinated with an injection molding cycle.

19. A mold insert comprising:
a support frame having a first side and a second side;
an active layer having a first side and a second side, wherein said active layer is disposed on said first side of said support frame;
a plurality of generally orthogonal ribs extending from said second side of said active layer, wherein said generally orthogonal ribs form a plurality of cells;
a plurality of nozzles disposed within said cells, wherein said nozzles are directed at said second side of said active layer, and wherein said nozzles are further provided with a supply of fluid heat-transfer medium.

20. The mold of claim 19, wherein said nozzles are disposed on vertical tubes, wherein said fluid heat-transfer medium is conveyed to said nozzles through said vertical tubes.

21. The mold of claim 20 wherein at least one of said vertical tubes contain more than one nozzle.

22. A method of thermally regulating an injection mold, said mold having a support frame and an active layer disposed therein, said active layer having a cavity defining surface and a rear surface, said rear surface possessing a plurality of compartments extending off of said rear surface, and a plurality of nozzles disposed within said compartments, said method comprising impinging said rear surface of said active layer with a fluid heat transfer medium, said fluid heat transfer medium being delivered from said nozzles.
